(19) United States
(12) Patent Application Publication
(10) Pub. No.: US 2020/0313332 A1
(43) Pub. Date: Oct. 1, 2020

(54) ELECTRICAL CONNECTOR WITH FLOATING CONTACT ELEMENT

(71) Applicant: METHODE ELECTRONICS, INC., Chicago, IL (US)

(72) Inventors: Chip BRONK, San Jose, CA (US); Hannah HAN, Fremont, CA (US); Robert KELLER, Rolling Meadows, IL (US); Michael STIBGEN, Rolling Meadows, IL (US)

(21) Appl. No.: 16/829,921

(22) Filed: Mar. 25, 2020

Related U.S. Application Data
(60) Provisional application No. 62/823,257, filed on Mar. 25, 2019.
(60) Provisional application No. 62/916,857, filed on Oct. 18, 2019.

(51) Int. Cl. H01R 13/20; H01R 13/24; H01R 13/631

(52) U.S. Cl. CPC H01R 13/20; H01R 13/2471; H01R 13/6315; H01R 13/2407

(57) ABSTRACT

An electrical connector for use with a separable mating connector includes base and a contact element captively received within the base. The contact element may be laterally or laterally and pivotably displaceable with respect to the base.

### CROSS-REFERENCE TO RELATED APPLICATIONS

This application claims benefit under 35 U.S.C. § 119 of U.S. Provisional Patent Application No. 62/823,257, filed on Mar. 25, 2019, and U.S. Provisional Patent Application No. 62/916,857, filed on Oct. 18, 2019, and it incorporates by reference the disclosures thereof in their entireties.

In addition, the subject matter of the following applications is incorporated herein by reference in its entirety: U.S. Utility application Ser. No. 16/829,672 filed Mar. 25, 2020, and entitled ELECTRICAL CONNECTOR WITH FLOATING CONTACT ELEMENT (B&T Ref. No. 49072-318243); U.S. Utility application Ser. No. 16/829,747 filed Mar. 25, 2020, and entitled ELECTRICAL CONNECTOR WITH FLOATING CONTACT ELEMENT (B&T Ref. No. 49072-318286); and U.S. Utility application Ser. No. 16/829,877 filed Mar. 25, 2020, and entitled ELECTRICAL CONNECTOR WITH FLOATING CONTACT ELEMENT (B&T Ref. No. 49072-318287).

### BACKGROUND OF THE DISCLOSURE

An electrical equipment cabinet may include a bus bar bearing a number of electrical connector sockets received in corresponding holes in the bus bar. A piece of electrical equipment may include mating electrical connector pins configured for insertion into the connector sockets borne by the bus bar.

Failure to precisely locate the connector sockets with respect to the bus bar and/or the connector pins with respect to the electrical equipment, for example, due to manufacturing tolerances, can result in misalignment of the sockets and pins. Such misalignment can inhibit or adversely affect the quality of the electrical connection between corresponding sockets and pins.

### BRIEF DESCRIPTION OF THE DRAWINGS

FIG. 1 illustrates a bus bar defining four apertures and four electrical connector sockets disposed in the apertures;

FIG. 2 is a side cross-sectional view of an illustrative electrical contact element;

FIG. 3 is a top plan view of the contact element of FIG. 2;

FIGS. 4A-4C are various views of a first illustrative embodiment of an electrical connector having a floating contact element, according to the present disclosure;

FIG. 5 is a cut-away perspective view of an illustrative mating connector according to the present disclosure for use with the connector of FIGS. 4A-4C;

FIG. 5A is a cut-away perspective view of the mating connector of FIG. 5;

FIGS. 6A-6C are various views of a second illustrative embodiment of an electrical connector having a floating contact element, according to the present disclosure; and

FIGS. 7A-7D are various views of a third illustrative embodiment of an electrical connector having a floating contact element, according to the present disclosure.

### DETAILED DESCRIPTION OF THE DRAWINGS

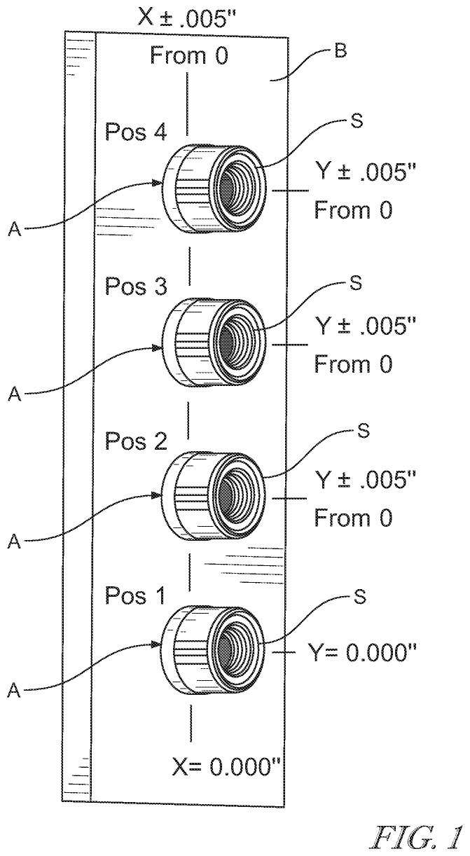

FIG. 1 shows an illustrative bus bar B as might be found in an electrical equipment cabinet (not shown). The bus bar B defines four apertures A arranged linearly proximate four corresponding, predetermined aperture locations. FIG. 1 also illustrates four electrical connector sockets S, each disposed within a corresponding one of the apertures A. Each of the electrical connector sockets S defines a cylindrical bore configured to receive a pin of a mating electrical connector (not shown in FIG. 1). The electrical connector sockets S are design so that the bores defined thereby are concentric with bodies thereof and concentric with the apertures A. As suggested by FIG. 1, the actual locations of the apertures A mighty vary somewhat from the predetermined aperture locations due to manufacturing tolerances. Similarly, the bores defined by the electrical connector sockets S might not be concentric with the bodies thereof due to manufacturing tolerances. FIG. 1 shows a non-limiting example of such deviation of aperture and bore locations from the respective design locations,

The predetermined aperture locations may correspond to predetermined locations of corresponding, mating electrical connector pins extending from a piece of electrical equipment (not shown) that may be removably received within the cabinet (not shown). The piece of electrical equipment may be, for example, an electrical equipment drawer removably receivable within the cabinet, or a piece of electrical equipment mounted on such a drawer. The actual locations of the pins (not shown) may vary somewhat from the respective predetermined aperture locations due to manufacturing tolerances.

The foregoing deviations of the aperture and pin locations from the respective predetermined locations, as well as manufacturing variations in the sockets S and the pins (not shown) themselves, can yield misalignment of respective sockets and pins. At worst, the misalignment may preclude insertion of the pins into the respective sockets. In less severe cases, the misalignment may adversely affect the quality of the electrical connection between the respective pins and sockets.

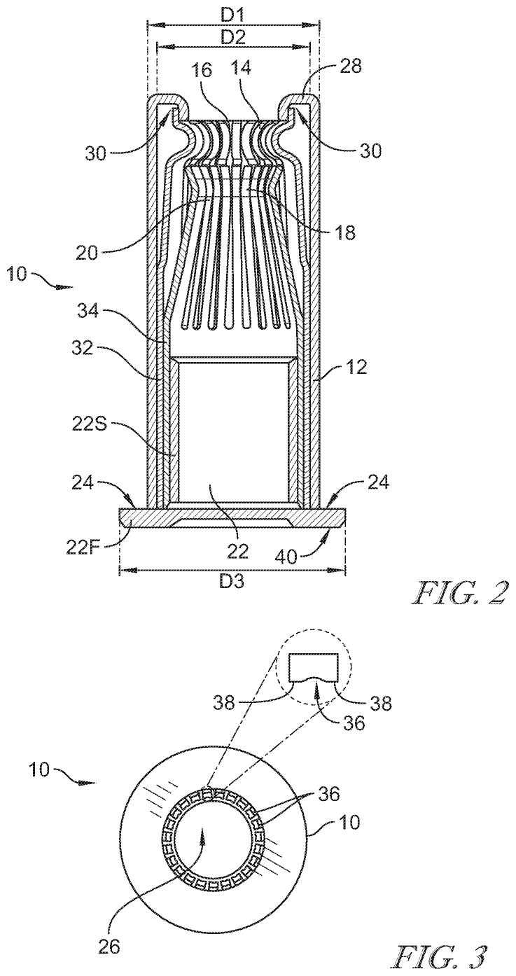

FIGS. 2 and 3 show an illustrative electrical contact element 10 including a generally cylindrical housing 12, a first generally cylindrical array 14 of flexible beams 16 received concentrically within the housing 12, a second generally cylindrical array 18 of flexible beams 20 received concentrically within the first array 14 of flexible beams 16, and a ferrule 22 having a generally cylindrical shaft 22S received concentrically within the second array 18 of flexible beams 29. The ferrule 22 also has a flange 22F from which the shaft 22S extends, the flange generally abutting an end of the housing 12. Individually and collectively, the housing 12, the first array 14, the second array 18, and the ferrule 22 define a cavity 24 configured to separably receive a mating connector, for example without limitation, the mating connector 200 shown in FIG. 5.

The housing 12 is shown as an annular sidewall having a first end and a second end. The sidewall of the housing 12 has an outer diameter D1 and an inner diameter D2. A hood 28 extends radially inwardly from the second end of the housing 12 and then turns toward the first end of the housing 12, thereby defining an annular channel or slot 30 between the sidewall of the housing 12 and the free end of the hood 28.

The first array 14 of flexible beams 16 is shown as extending from a generally cylindrical base 32 abutting the housing 12 proximate the first end thereof. The first array 14 of beams 16 extends axially from the base 32 and radially inwardly toward the center of the cylinder defined by the first array 14 of flexible beams 15. Similarly, the second array 18 of flexible beams 20 is shown as extending from a generally cylindrical base 34 abutting the base 32 of the first array 14 of flexible beams 16 proximate the first end thereof. The first array 18 of flexible beams 20 extends axially from the base 34 and radially inwardly toward the center of the cylinder defined by the second array 18 of flexible beams 20. In an embodiment, the second array 18 of flexible beams 20 may be omitted. In other embodiments, other electrical contact arrangements defining a cylindrical cavity could be provided in lieu of either or both of the arrays 14, 18 of flexible beams 16, 20.

As suggested above, the ferrule 22 includes a generally circular flange 22F defining an aperture therethrough, and a generally annular shaft 22S defining a bore extending therethrough. The shaft 22S is connected to the flange 22F so that bore of the shaft 22S is generally concentric with the aperture of the flange 22F. The flange 22F has a second outer diameter D3 substantially greater than the first outer diameter D1 of the housing 12. As such, the flange 22F defines a bearing surface or land 24 extending radially outwardly from the sidewall of the housing 12.

All of the foregoing components of the contact element 10 are electrically conductive, and they are electrically coupled to each other. The first inner diameter D2 of the housing 12, the outer diameter D3 of the shaft 22S, and the diameters of the bases 32, 34 of the first and second arrays 14, 18 of flexible beams 16, 20 are selected so that the bases 32, 34 are compressed against each other and between the housing 12 and the ferrule 22 when the housing 12, the first and second bases 32, 34, and the ferrule 22 are assembled as shown and as described above.

As best shown in FIG. 3, the distal portion of each of the flexible beams 16, 20 extending from the respective base 32, 34 defines a contact area 36 configured to engage the mating connector 200 in electrical contact therewith. In some embodiments, the contact area 36 may be formed to define two contact points or surfaces 38. In other embodiments, the contact areas 36 may be formed to define more or fewer than two contact points or surfaces 38. As best shown in FIG. 2, the distal end of each beam of the first array 14 of flexible beams 16 may be radially captured within the slot 30 defined by the sidewall of the housing 12 and the free end of the hood 28.

As suggested above, the contact element 10 may be configured to receive therein a pin 204 of a mating connector element 200 in electrical engagement, so that low force is required to assemble the mating connector element to, and to disassemble the mating connector element from, the contact element 10. A non-limiting example of such a mating connector element 200 is shown in FIG. 5.

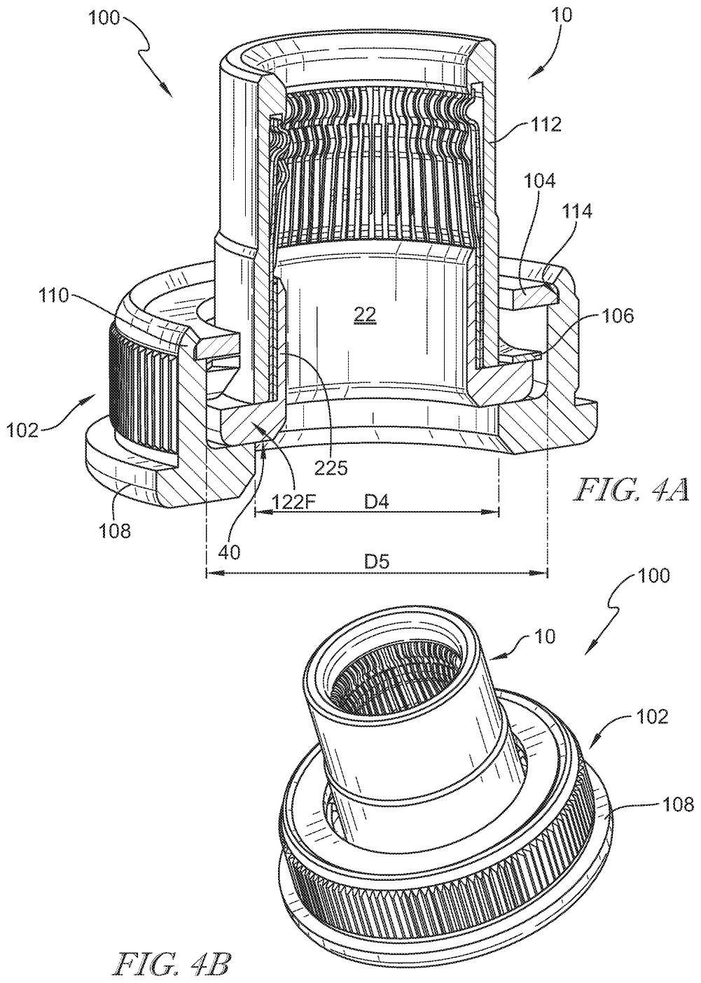

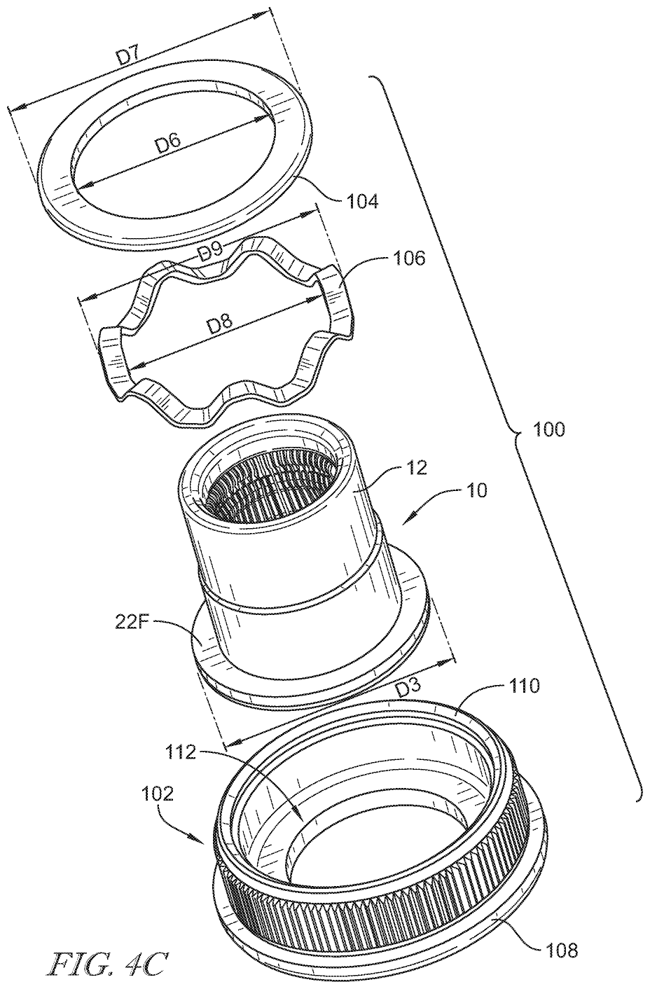

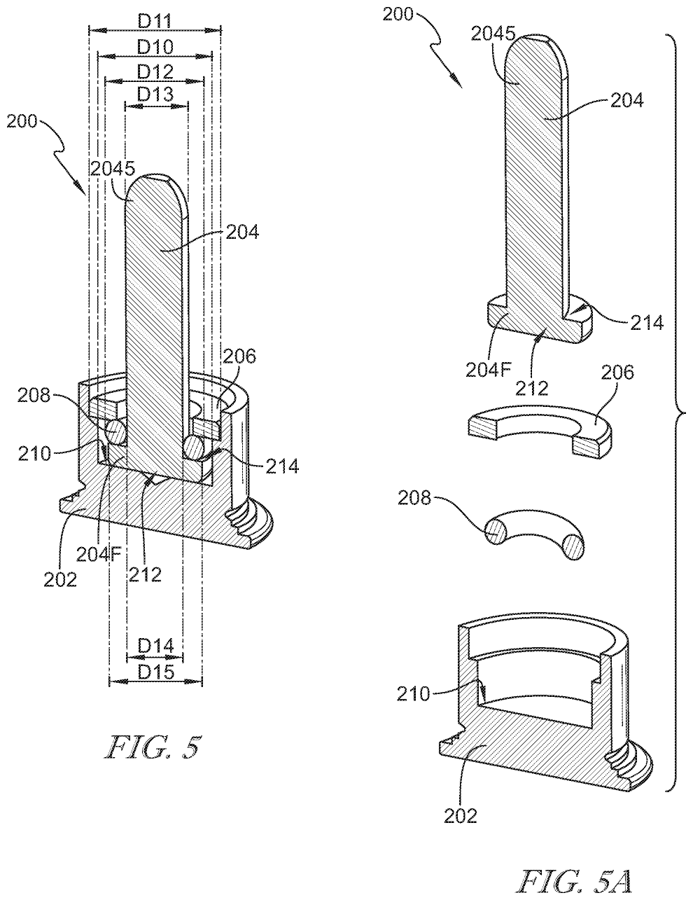

FIGS. 4A-4C show a first illustrative embodiment of an electrical connector 100 according to the present disclosure. The connector 100 includes the contact element 10, a generally circular/cylindrical mounting base 102 configured to receive the flange 22F of the ferrule 22 of the contact element 10, a retainer 104 configured to capture the flange 22F, and a biasing element 106 disposed between the retainer 104 and the flange 22F. The biasing element 106 biases the flange 22F toward the base 102.

More specifically, the base 102 includes a generally circular flange 108 defining an aperture therethrough. The aperture defined by the flange 108 has a diameter D4 substantially less than the outer diameter D3 of the flange 22F of the ferrule 22. A generally cylindrical sidewall 110 defining a bore therethrough extends axially from the flange 108, with the bore of the sidewall generally concentric with the aperture of the flange 108. The bore defined by the sidewall 110 has an inner diameter D5 substantially greater than the outer diameter D3 of the flange 22F of the ferrule 22, thereby allowing substantial lateral (or radial) displacement of the flange 22F with respect to the sidewall 110 when the contact element 10 is assembled to the base 102 as shown and as will be discussed further below. Also, the flange 108 and the sidewall 110 cooperate to define a land 112 within the sidewall 110. The land 112 is configured to abut a lower surface 40 of the flange 22F of the ferrule 22 and to support the flange 22F in bearing engagement when the contact element 10 is assembled to the base 102 as shown and as will be discussed further below. The inner surface of the sidewall 110 may define a circumferential groove 114 configured to receive an outer edge of the retainer 104. The outer surface of the sidewall 110 may be knurled.

The retainer 104 is shown as a retaining ring defining an aperture therethrough. The aperture has an inner diameter D6 sufficiently greater than the outer diameter D1 of the housing 12 of the connector element 10 to allow the housing 12 to be received through the aperture of the retainer 104 when the contact element 10 is assembled to the retainer 104, thereby allowing substantial lateral (or radial) displacement of the housing 12 of the contact element 10 with respect to the retainer 104 when the contact element 10 is assembled to the base 102 and the retainer as shown and as will be discussed further below. Also, the retainer 104 has an outer diameter D7 substantially greater than the inner diameter D5 of the sidewall 110 of the base 102, thereby enabling the retainer 104 to be securely received within the groove 114 of the base 102, and thereby inhibiting unintended disassembly of the assembled connector 100.

The biasing element 106 is shown in the drawings as a wave washer, but it could be embodied in other forms. For example, without limitation, the biasing element 106 could be embodied as an O-ring or other flexible and resilient structure. The biasing element 106 has an inner diameter D8 sufficiently greater than the outer diameter D1 of the housing 12 of the contact element 10 to allow the housing 12 to be received through the biasing element 106 and to allow substantial radial displacement of the contact element 10 with respect to the base 102 when the contact element 10 is assembled to the retainer 102 as shown and as will be discussed further below. The biasing element 106 has an outer diameter D9 sufficiently lesser than the inner diameter D5 of the sidewall 110 of the base 102 to thereby allow the biasing element 106 to be received within the base 102. The outer diameter D8 of the biasing element 106 may be sufficiently lesser that the inner diameter D 5 of the sidewall 110 of the base 102 to allow substantial lateral (or radial) displacement of the housing 12 and the biasing element 106 with respect to the base 102 when the contact element 10 is assembled to the base 102 and the retainer 104 as shown, and as will be discussed further below.

The connector 100 may be assembled by inserting the contact element 10 into the base 102 with a lower surface 40 of the flange 22F of the ferrule 22 in sliding engagement with the land 112 defined by the base 102. The biasing element 106 may be inserted into the base 102 and into abutment with the land 24 defined by the flange 22F of the ferrule 22, and with the housing 12 of the contact element 10 received within the aperture of the biasing element 106. The retainer 104 may be inserted in the base 102 and into engagement with the groove 114, with the housing 12 received within the aperture of the retainer 104. With the connector 100 so assembled, the biasing element 106 biases the flange 22F of the ferrule 22 toward the land 112 of the base 102.

Because the outer diameter D3 of the flange 22F of the ferrule 22 is substantially less than the inner diameter D5 of the sidewall 110, because the outer diameter D8 of the biasing element 106 is substantially less than the inner diameter D5 of the sidewall 110, and because the outer diameter D1 of the housing 12 is substantially less than the diameter D6 of the aperture defined by the retainer 104, the entire contact element 10 is substantially displaceable at least radially with respect to the base 102. In some embodiments, the contact element 10 also may be substantially displaceable axially with respect to the base 102. As such, in some embodiments, there may be sufficient axial and radial play among the flange 108, the flange 22F, the biasing element 104, and the retainer 106 to permit substantial pivoting of an axis (for example, a longitudinal axis) of the contact element 10 with respect to a corresponding axis of the base 102 and the retainer 104. In other embodiments, there may be insufficient axial play among the flange 108, the flange 22F, the biasing element 104, and the retainer 106 to permit substantial pivoting of the contact element 10 with respect to the base 102 and the retainer 104.

FIG. 5 shows an illustrative mating electrical connector 200 that may be used in connection with the electrical connector 100. The mating electrical connector 200 also may be used in connection with electrical connectors including the contact element 10, and other electrical connectors having an appropriately configured cylindrical cavity. The mating connector 200 includes a generally cylindrical base 202, a pin 204 extending from the base, a retainer 206 capturing the pin to the base, and a biasing element 208 disposed between a generally circular flange 204F of the pin and the retainer 206.

The base 202 is generally cylindrical, with a bore extending inwardly from one end thereof. As shown, the bore may be blind. The bore has a minor inner diameter D10 and a major inner diameter D11. The bottom of the bore defines a surface 210.

As mentioned above, the pin 204 includes a generally circular flange 204F. The pin also includes a generally cylindrical shaft 204S extending perpendicularly from a first side of the flange 204F. A second side of the flange 204F opposite the first side defines a lower surface 212 thereof. The flange 204F has a diameter D12 greater than a diameter D13 of the shaft 204S. As such, the flange 204F and the shaft 204S cooperate to define a circumferential land 214 extending radially outwardly from the shaft 204S. The diameter D12 of the flange 204F is substantially less than the minor diameter D10 of the bore of the base 202 so that the flange 204F may move laterally with respect to the base 202 when received thereby, as shown and as will be discussed further below.

The biasing element 208 is shown as a rubber or other flexible and resilient O-ring, but it could be embodied in other ways. The biasing element 208 has an inner diameter D12 sufficiently greater than the outer diameter D11 of the shaft 204S of the pin 204 to allow the shaft 204S of pin 204 to be received through the biasing element 208 when the biasing element 208 is assembled to the pin 204 as shown and as will be discussed further below. The biasing element 208 has an outer diameter D15 substantially lesser than the minor inner diameter D10 of the bore of the base 202, thereby allowing substantial lateral (or radial) displacement of the pin 204 and the biasing element 208 with respect to the base 202 when the biasing element 208 is assembled to the base 202 and the pin 204 as shown and as will be discussed further below.

The retainer 206 is similar to the retainer 104, and the retainer 206 interacts with the base 202 and the pin 204 in a manner similar to that in which the retainer 104 interacts with the base 102 and the housing 12. The retainer 206 has an inner diameter D16 sufficiently greater than the outer diameter D11 of the shaft 204S of the pin 204 to allow the pin shaft 204S of the pin 204 to be received through the retainer 206 when the retainer 206 is assembled to the pin 204 as shown and as will be discussed further below. The retainer 206 has an outer diameter D17 configured to interact with the bore of the base 202 or an engagement feature thereof (not shown) to secure the retainer 206 to the base 202. The engagement feature may be, for example without limitation, a groove similar to the groove 114.

The mating connector 200 may be assembled by inserting the pin 204 into the base 202 with the lower surface 212 of the pin in sliding engagement with the surface 210 defined by the base 202. The biasing element 208 may be inserted into the base 202 and into abutment with the land 214 defined by the flange 204F of the pin 204, and with the shaft 204S of the pin 204 received within the aperture of the biasing element 208. The retainer 206 may be inserted in the base 202 and into engagement with a corresponding engagement feature of the base 202, with the shaft 204S of the pin 204 received within the aperture of the retainer 206. With the mating connector 200 so assembled, the biasing element 208 biases the flange 204F of the pin 204 toward the surface 210 of the base 202.

Because the outer diameter D12 of the flange 202F of the pin 204 is substantially less than the minor inner diameter D10 of the bore of the base 202, because the outer diameter D12 of the biasing element 208 is substantially less than the inner diameter D8 of the base 202, and because the outer diameter D10 of the shaft 204S of the pin 204 is substantially less than the diameter D13 of the aperture defined by the retainer 206, the entire pin 204 is substantially displaceable at least radially with respect to the base 202. In some embodiments, the pin 204 also may be substantially displaceable axially with respect to the base 102. As such, in some embodiments, there may be sufficient axial and radial play among the surface 210 of the base 202, the flange 204F of the pin 204, the biasing element 208, and the retainer 206 to permit substantial pivoting of an axis (for example, a longitudinal axis) of the flange 204F of the pin 204 with respect to a corresponding axis of the base 202 and the retainer 206. In other embodiments, there may be insufficient axial play among the surface 210 of the base 202, the flange 204F of the pin 204, the biasing element 208, and the retainer 206 to permit substantial pivoting of the pin 204 with respect to the base 202 and the retainer 206.

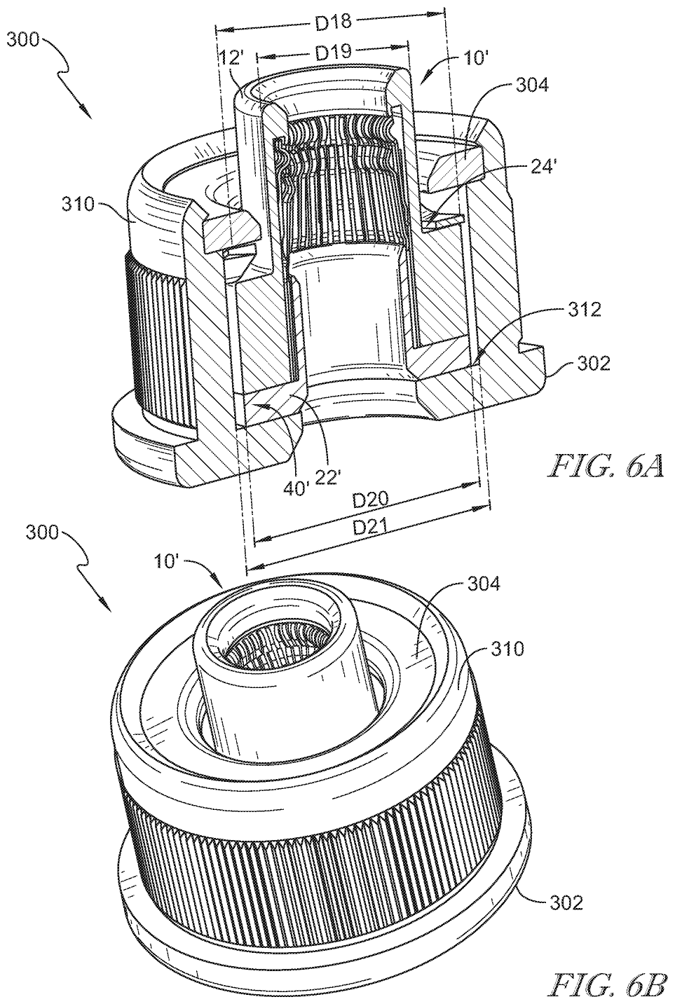

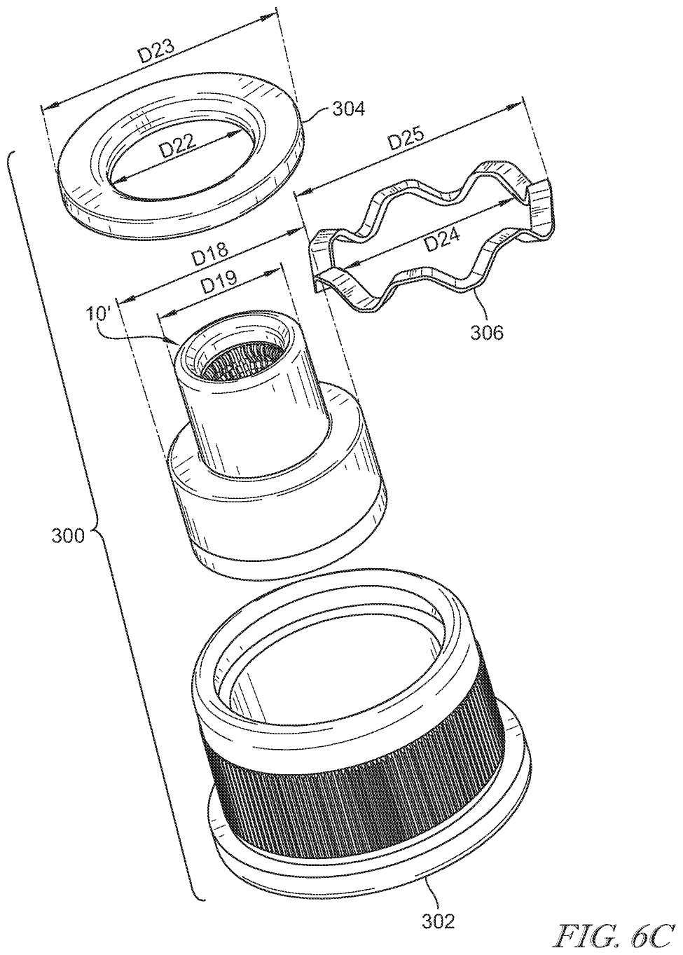

FIGS. 6A-6C show a second illustrative embodiment of an electrical connector 300 according to the present disclosure. The connector 300 includes a contact element 10′. The contact element 10′ is in most respects the same as or substantially similar to the contact element 10. As such, components of the contact element 10′ having counterparts in the contact element 10 will be identified and/or discussed herein using like, but primed, reference characters. The following discussion of the contact element 10′ is directed to differences between it and contact element 10.

The contact element 10′ includes a housing 12′ having a stepped outer wall profile. More specifically, the housing 12′ has a first portion having a first outer diameter D18 proximate a first end thereof and a second portion having a second outer diameter D19 proximate a second end thereof. The first outer diameter D18 is substantially greater than the second outer diameter D19. As such, the first portion of the housing 12′ cooperates with the second portion of the housing 12′ to define a land 24′ similar to the land 24 but defined by the housing 12′, rather than by a ferrule 22′, as will be discussed further below.

The contact element 10′ also includes a ferrule 22′ having a flange 22F and a shaft 22S′ extending from the flange. The flange 22F′ has a diameter D20 about the same as the diameter D18 of the first portion of the housing 12′.

The connector 300 also includes a base 302 and a retainer 304 configured to receive and capture the contact element 10′. The base 302 is similar to the base 102, but may be taller to accommodate the housing 12 of the contact element 10′, which may be taller than the housing 12 of the contact element 10. The retainer 304 is similar to the retainer 104 and it interacts with the base 302 in the same manner that the retainer 104 interacts with the base 102. As such, the base 302 has a sidewall 310 defining a bore having an inner diameter D21. Also, the retainer 304 has an inner diameter D22 and an outer diameter D23.

The connector 300 further includes a biasing element 306. The biasing element 306 is similar to the biasing element 106. As such, the biasing element 306 defines an aperture having a diameter D24, and it has an outer diameter D25.

The connector 300 may be assembled by inserting the contact element 10′ into the base 302 with a lower surface 40′ of the flange 22F′ of the ferrule 22′ in sliding engagement with the land 312 defined by the base 302. The biasing element 306 may be inserted into the base 102 and into abutment with the land 24′ defined by the housing 12′, and with the housing 12 received within the aperture of the biasing element. The retainer 304 may be inserted in the base 302 and into engagement therewith, with the housing 12′ received within the aperture of the retainer 304. With the connector 300 so assembled, the biasing element 306 biases the housing 12′ and the ferrule 22′ toward the land 312 of the base 302.

Because the first and second outer diameters D18, D18 of the housing 12′ and the outer diameter D20 of the flange 22F′ of the ferrule 22′ are substantially less than the inner diameter D21 of the sidewall 310, because the outer diameter D25 of the biasing element 306 is substantially less than the inner diameter D21 of the sidewall 310, and because the second outer diameter D18 of the housing 12′ is substantially less than the diameter D22 of the aperture defined by the retainer 304, the entire contact element 10′ may be substantially displaceable at least radially with respect to the base 302. In some embodiments, the contact element 10′ also may be substantially displaceable axially with respect to the base 302 and the retainer 204. As such, in some embodiments, there may be sufficient axial and radial play among the flange 308, the flange 22F′, the housing 12′, the biasing element 306, and the retainer 304 to permit substantial pivoting of an axis (for example, a longitudinal axis) of the contact element 10′ with respect to a corresponding axis of the base 302 and the retainer 304. In other embodiments, there may be insufficient axial play among the flange 308, the flange 22F, the housing 12′, the biasing element 306, and the retainer 304 to permit substantial pivoting of the contact element 10′ with respect to the base 302 and the retainer 304.

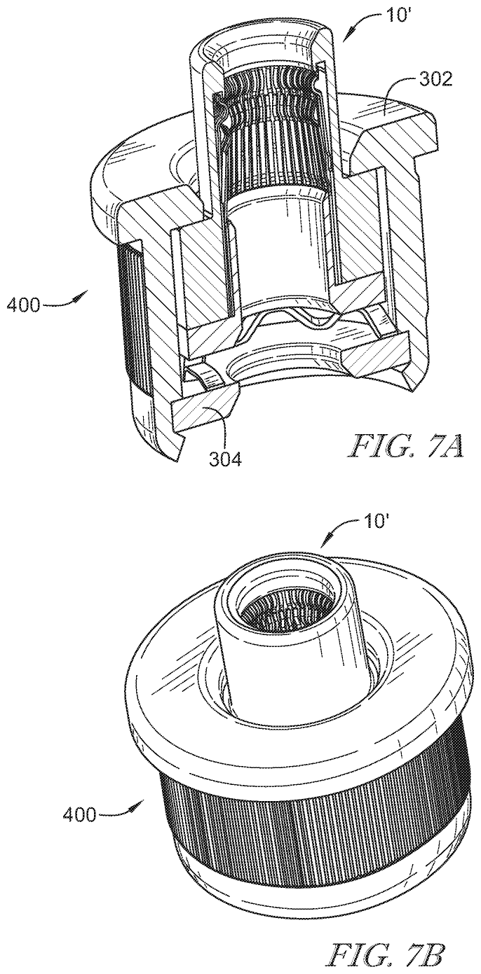

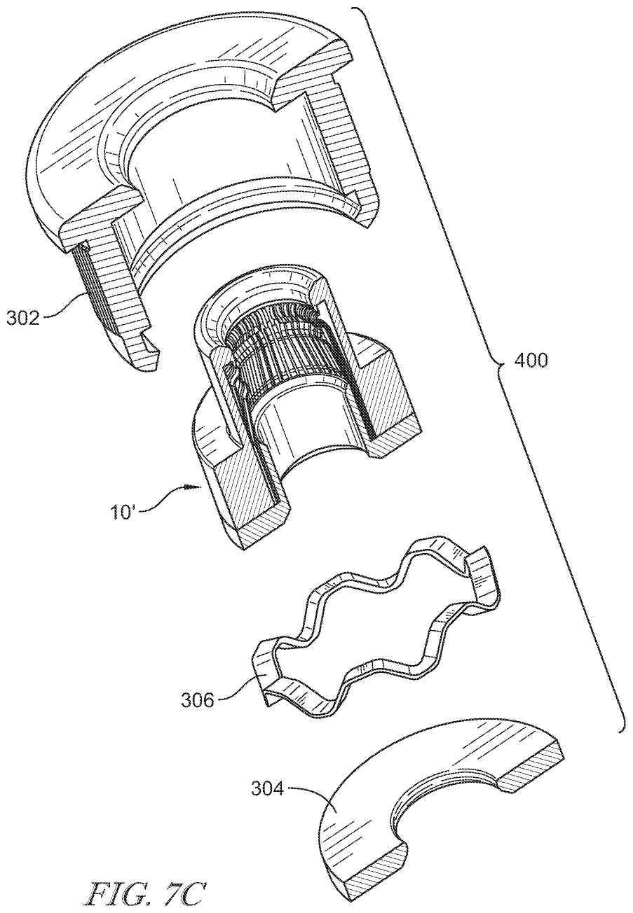

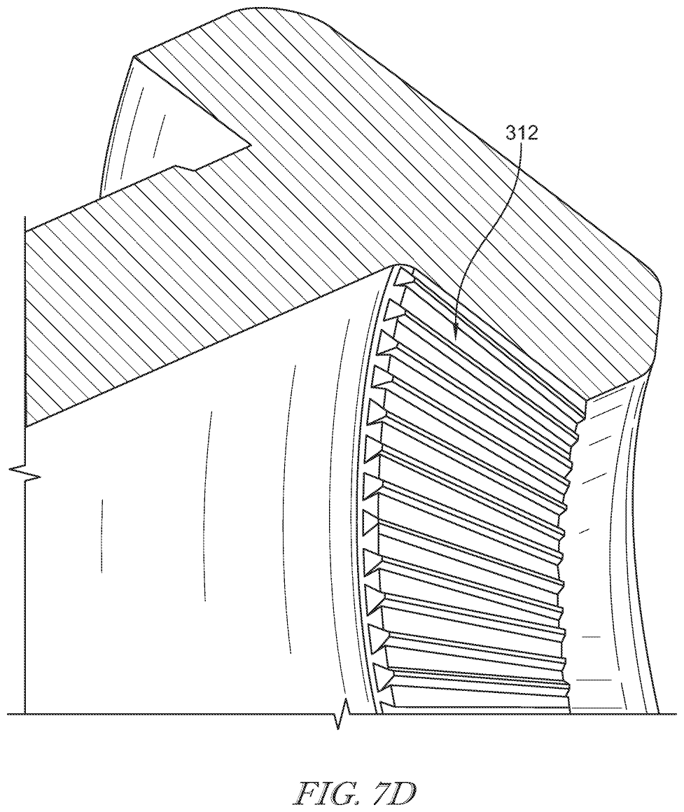

FIGS. 7A-7D show a third illustrative embodiment of an electrical connector 400 according to the present disclosure. The connector 400 is substantially similar to, and includes the same components as, the connecter 300. The connector 400 differs from the connector 300 in that the orientation of the contact element 10′ with respect to the base 302 and the retainer 304 in the connector 400 is inverted compared to the orientation of the contact element 10′ with respect to the base 302 and the retainer 304 in the connector 300. Also, FIG. 7D shows that the land 312 defined by the base 302 may be knurled. The knurling may serve to improve the electrical contact between the land 312 defined by the base 302 and the abutting surface of the contact element 10′.

Various illustrative, non-limiting embodiments of an electrical connector and mating connector are shown and described herein. Features shown in connection with a given embodiment may be incorporated into any other embodiment to the greatest extent possible. Dimensions, tolerances, and the like that may be shown or described herein are illustrative and not limiting.

1. An electrical connector for use with a separable mating electrical connector, the electrical connector comprising:
a cylindrical base configured for secure insertion into an aperture defined by a bus bar, the cylindrical base defining a bore having an inner diameter, and the cylindrical base having a longitudinal axis;
a cylindrical contact element disposed within the bore of the cylindrical base, the cylindrical contact element having a first end and a second end, the cylindrical contact element defining a bore configured to receive a pin of the separable mating connector in continuous electrical engagement therewith, the cylindrical contact element comprising:
a cylindrical housing having an inner diameter and an outer diameter lesser than the inner diameter of the bore of the cylindrical base; and
a land extending radially outwardly from the cylindrical housing proximate the first end of the cylindrical housing, the land having an outer diameter; and
a retainer receiving the cylindrical contact element therein and capturing the cylindrical contact element to the cylindrical base,
wherein the outer diameter of the housing of the cylindrical contact element and the inner diameter of the bore of the cylindrical base are selected to allow substantial radial movement of the cylindrical contact element with respect to the cylindrical base; and
wherein the cylindrical contact element is electrically engaged with the cylindrical base.

2. The electrical connector of claim 1 further comprising a biasing element disposed within the base and axially between the land of the cylindrical contact element and the cylindrical retainer.

3. The electrical connector of claim 1 wherein the annular biasing element comprises a wave washer.

4. The electrical connector of claim 2 wherein the annular retainer is engaged with a circumferential groove defined by an inner surface of the cylindrical base.

5. The electrical connector of claim 2 wherein a distance between the land and the retainer is selected to allow substantial axial movement of the land with respect to the base.

6. The electrical connecter of claim 1 further comprising a first cylindrical array of flexible beams extending toward the second end of the housing of the cylindrical contact element from a base disposed radially within the housing of the cylindrical contact element and proximate the first end of the housing of the cylindrical contact element.

7. The electrical connector of claim of claim 6 further comprising a second cylindrical array of flexible beams extending toward the second end of the housing of the cylindrical contact element from a base disposed radially within the base of the first array of flexible beams of the cylindrical contact element and proximate the first end of the housing of the cylindrical contact element.

8. The electrical connector of claim 1 wherein the cylindrical contact element further comprises a ferrule having an annular shaft and a circular flange connected to the annular shaft at a first end thereof, the annular shaft received radially within the housing, and the annular flange defining the land.

9. A electrical connector for use with a separable mating electrical connector, the electrical connector compromising:
a cylindrical base having a first end and a second end, the cylindrical base defining a bore extending axially inwardly from the second end thereof, the bore having an inner diameter;
a contact element received within the bore of the cylindrical base, the contact element comprising a shaft having a first end and a second end, and a flange connected to the shaft proximate the first end thereof, each of the shaft and the flange having an outer diameter; and
a retainer having an inner diameter and an outer diameter;
wherein the inner diameter of the base, the outer diameter of the flange, and the inner diameter of the retainer are selected to enable substantial radial movement of the contact element with respect to the housing, and wherein the contact element is electrically engaged with the cylindrical base.

10. The electrical connector of claim 8 further comprising a biasing element disposed within the cylindrical base and axially between the land of the annular contact element and the annular retainer.

11. The electrical connector of claim 9 wherein the biasing element comprises a flexible and resilient material.

12. The electrical connector of claim 9 wherein the annular retainer is configured to securely engage with an inner circumferential surface of the cylindrical base.

13. The electrical connector of claim 12 wherein the inner surface of the cylindrical base is a circumferential groove defined by the cylindrical base.

14. The electrical connector of claim 9 wherein a distance between the flange and the retainer is selected to allow substantial axial movement of the flange with respect to the cylindrical base.

15. An electrical connector for use with a separable mating electrical connector, the electrical connector comprising:
a base configured for secure insertion into an aperture defined by a bus bar, the base defining a bore having an inner diameter, and the base having a longitudinal axis;
a contact element disposed within the bore of the base, the contact element having a first end and a second end, the contact element defining a bore configured to receive a pin of the separable mating connector in continuous electrical engagement therewith, the contact element comprising:
a housing having an inner diameter and an outer diameter lesser than the inner diameter of the bore of the base; and
a land extending radially outwardly from the housing proximate the first end of the housing, the land having an outer diameter; and
a retainer receiving the contact element therein and capturing the contact element to the base,
wherein the outer diameter of the housing of the contact element and the inner diameter of the bore of the base are selected to allow substantial radial movement of the contact element with respect to the base; and
wherein the contact element is electrically engaged with the base.

16. The electrical connector of claim 15 further comprising a biasing element disposed within the base and axially between the land of the contact element and the retainer.

17. The electrical connector of claim 16 wherein the retainer is engaged with a circumferential groove defined by an inner surface of the base.

18. The electrical connector of claim 16 wherein a distance between the land and the retainer is selected to allow substantial axial movement of the land with respect to the base.

19. The electrical connecter of claim 15 further comprising a first cylindrical array of flexible beams extending toward the second end of the housing of the contact element from a base disposed radially within the housing of the contact element and proximate the first end of the housing of the contact element.

20. The electrical connector of claim 15 wherein the contact element further comprises a ferrule having a shaft and a flange connected to the shaft at a first end thereof, the shaft received radially within the housing, and the flange defining the land.
